(19) United States
(12) Patent Application Publication
(10) Pub. No.: US 2023/0354905 A1
(43) Pub. Date: Nov. 9, 2023

(54) Liquid-Tight Refillable Cartridge for an Electronic Smoking Device

(71) Applicant: JT International SA, Geneva (CH)

(72) Inventors: Damian Dickson, Ballymena, Co Antrim (GB); Pifa Shen, Shenzhen, Bao'an District (CN)

(73) Assignee: JT International SA, Geneva (CH)

(21) Appl. No.: 18/025,539

(22) PCT Filed: Sep. 24, 2021
(86) PCT No.: PCT/EP2021/076354

§ 371 Date: Mar. 9, 2023

(30) Foreign Application Priority Data
Sep. 24, 2020 (WO) PCT/CN2020/117450

(51) Int. Cl. A24F 40/485; A24F 40/10; A24F 40/42; A24F 40/70; B65B 3/04; F16K 15/14

(52) U.S. Cl. CPC A24F 40/485; A24F 40/10; A24F 40/42; A24F 40/70; B65B 3/04; F16K 15/1471

(57) ABSTRACT

A refillable cartridge for an electronic smoking device includes a cartridge housing, a liquid storage reservoir, and an energy application device for generating an aerosol from liquid received from the reservoir, wherein the reservoir includes an opening having an opening width, which is temporary closed by a sealing layer including a valve, wherein the valve includes a valve member which is overlapping at least parts with the opening along its width direction, the valve member is bendable in an opening direction, which is orthogonal to the width direction, and a thickness of the valve member in the opening direction differs along its width direction. A method for manufacturing a refillable cartridge and a method for refilling a refillable cartridge are also provided.

### CROSS-REFERENCE TO RELATED APPLICATIONS

The present application is a national phase entry under 35 U.S.C. § 371 of International Application No. PCT/EP2021/076354, filed Sep. 24, 2021, published in English, which claims priority to International Application No. PCT/CN2020/117450 filed Sep. 24, 2020, the disclosures of which are incorporated herein by reference.

### FIELD OF THE INVENTION

The invention relates to a refillable cartridge for an electronic smoking device, comprising a cartridge housing as a liquid storage reservoir and an energy application device for generating an aerosol from liquid received from the reservoir, wherein the reservoir comprises an opening having an opening width, which is temporary closed by a sealing layer comprising a valve, wherein the valve comprises a valve member which is overlapping at least in parts with the opening along its width direction.

### BACKGROUND

To refill an available refillable cartridge, the sealing layer often has to be completely removed from the opening of the refillable cartridge. With the removed sealing layer new liquid can be filled in the cartridge. However, during this process spilling of the liquid is likely to happen. The reason for this spilling is either the completely removed sealing layer or a leaky valve. It is also possible that the sealing layer can get lost when removed from the cartridge during the refill process, which would make the electronic smoking device unusable.

### SUMMARY

Therefore, the objective of the invention is to provide a refillable cartridge with a sealing layer that is spill-proof, easy to use and comprises low-production cost.

The objective of the invention is reached by a refillable cartridge for an electronic smoking device comprising a cartridge housing and a liquid storage reservoir and an energy application device for generating an aerosol from liquid received from the reservoir, wherein the reservoir comprises an opening having an opening width, which is temporary closed by a sealing layer comprising a valve, wherein the valve comprises a valve member which is overlapping at least parts with the opening along its width direction. The invention is characterized in that the valve member is bendable in an opening direction, which is orthogonal to the width direction, and a thickness of the valve member in the opening direction differs along its width direction.

Upon insertion of a nozzle of a filling device into the valve, the valve member bends towards an interior of the liquid storage reservoir. By bending the valve member in the opening direction, the overlapping area of the valve member with the opening is reduced. This means, that the valve opens upon insertion of the nozzle of the filling device. The thickness of the valve member in the opening direction differs along its width direction. Preferably, the thickness is smallest at the center of the valve and thicker at the outer edge of the valve. With the thickness differences the bendability of the valve member is generated and can also be engineered depending on the material properties of the valve member and depending on the desired insertion force necessary to push the nozzle into the valve. The bending of the valve members preferably is an elastic strain and preferably not a plastic strain. This means that when the nozzle is retraced from the valve, the valve members return to their previous position. The valve is therefore self-resealing. The term “temporary” means in this context, that the sealing layer is removable from the refillable cartridge. For example for cleaning purposes.

According to another embodiment the sealing layer and the valve member comprise the same material, preferably a hydrophobic material. Hydrophobic materials generate poor wetting of the sealing layer and the valve member. This further enhances the spill-proofness. Preferably the hydrophobic material comprises a low energy surface. Preferably, the hydrophobic material comprises van-der-Waals bonds and hydrogen bonds as dominant bonds of the material. Preferably, the contact angle θ between the liquid and the sealing layer is between 90 and 180 degrees. Preferably, the liquid does not wet the sealing layer at all or does only wet the sealing layer partially. Preferably, the hydrophobic material is also lyophobic. Even more preferred, the hydrophobic material is also omniphobic.

According to another embodiment, a surface of the sealing layer and/or the valve member which is arranged towards the storage reservoir comprises a hydrophobic material, wherein preferably the sealing layer and/or the valve member consists of the hydrophobic material. The surface may also comprise other materials in addition to the hydrophobic material. The sealing layer and other valve members may consist of the very same hydrophobic material or may consist of any other suitable material. With this embodiment, a higher freedom of design possibilities regarding the material properties of the sealing layer and the valve member can be achieved. Preferably, the hydrophobic material is silicone. Preferably, the surface of the sealing layer comprises a nano- or microstructure. Preferably the nano- or microstructure is suitable to create super hydrophobicity. Preferably, the surface of the sealing layer comprises a microstructure generating a lotus effect.

According to another embodiment, the valve provides openings which allow passing of gases through the valve in a state in which transfer of liquids is inhibited. In other words, the valve seals the liquid storage reservoir only with respect to liquids but not with respect to gases. This means, that the sealing layer with the valve and the valve member is only liquid-tight but not air-tight. In this way, a pressure regulation of the cartridge is possible when the liquid is continuously emptied during the smoking process. The valve with the openings is also easier to manufacture due to larger production tolerances.

According to another embodiment, the valve member is defined by at least two, more preferably at least three, most preferably at least four elongated recesses which intersect each other in an intersection position, preferably in a single intersection position, wherein recesses preferably extend from the intersection position in an angle of at least 45°, preferably at least 60°, more preferably 80°, most preferably 90° with respect to each other. In a preferred version of this embodiment the recesses form a cross-shaped cut in the sealing layer. Between two neighboring recesses, a bendable portion of the valve member is created. In this way, it is very easy to create bendable portions of the valve member and therefore a bendable valve member.

According to another embodiment, the thickness of the valve member follows a thickness profile having a reduced thickness in a position closer to the intersection position than remote to the intersection position. Due to its thinning layer thickness towards the intersection position the valve member is easily bendable. At the same time the remaining sealing layer comprises a non-reduced thickness and therefore sufficient stability.

According to another embodiment, the thickness of the valve member follows a thickness profile having a continuous or stepwise decreasing thickness in a direction towards the intersection position. With the continuously or stepwise decreasing thickness profile, the bending properties of the valve member can be engineered. In particular, the force needed to bend the valve member in the opening direction can be engineered. Also, the restoration forces of the valve member for return in the original position after retracing the nozzle from the valve can be engineered. The careful engineering of the restoration forces also leads to the fact that the bendable portions of the valve member lie against the nozzle during the refilling process.

According to another embodiment, at least one recess follows a curvature of the opening. As the refillable cartridge preferably comprises a cylindrical shape, the opening of the cartridge preferably also comprises a circular shape. Often, the refillable cartridge comprises the shape of the hollow cylinder due to which the shape of the seal is a ring. With the limited available space on the seal surface, the at least one recess which follows a curvature of the opening can be arranged with sufficient distance to the seal edge. In particular, the at least one recess following the curvature of the opening can be arranged parallel to the edge of the seal. In this way a higher stability of the seal and the sealing layer can be achieved.

According to another embodiment at least one recess has a width smaller or equal to 1 mm, preferably larger than or equal to 0.005 mm and smaller than or equal to 0.8 mm, more preferably greater than or equal to 0.01 mm and smaller than or equal to 0.6 mm, most preferably greater than or equal to 0.02 mm and smaller than or equal to 0.5 mm. With this sizing the recesses are small enough to prohibit leakage with the corresponding surface energies, wetting angles, and droplet sizes of the liquid. Preferably, the liquid comprises propylene glycol and/or glycerin. Preferably, the relative density of the liquid is 1.08-1.18 g/cm³. Preferably, the viscosity of the liquid is 128-450 mPa·s measured at 20° C. Preferably, the surface tension of the liquid is 37-45 mN/m. These preferred parameters of the liquid lead to a liquid-tight seal at least for the material of silicone as a hydrophobic material. Other materials with hydrophobic properties comparable to silicone and comparable applicability to consumables may also be used as the hydrophobic material.

According to another embodiment, at least one recess has a length larger than or equal to 0.5 mm and smaller than or equal to 10 mm, preferably larger than 0.75 mm and smaller than or equal to 7.5 mm, more preferably larger than or equal to 0.9 mm and smaller than or equal to 5 mm, most preferably greater than or equal to 1 mm and smaller than or equal to 3 mm. With these dimensions in the recesses the valve is able to accommodate standard nozzles of standard refilling bottles, which in most cases comprise a diameter of the outlet opening of 0.8-1.0 mm and a diameter of the elongated member of 2.5-3.5 mm. Preferably, the refilling bottle is a 10 ml e-liquid refill bottle. Preferably the valve member comprises more than one recess, wherein at least two recesses comprise different lengths.

According to another embodiment, the flexibility of the valve member increases along its width direction towards the intersection position. The increasing flexibility may either be achieved due to the varying thickness profile or due to material differences towards the intersection position. For the first option, respective embodiments regarding the varying thickness profile were already discussed earlier. With regard to the latter option, a material comprising a higher flexibility could be used towards the intersection position, whereas a material comprising a lower flexibility could be used farther away from the intersection position. It is also conceivable that the two materials comprising the different flexibilities are mixed in a matrix-like material compound comprising a graded material composition towards the intersection position. In this case it is preferred that the material comprising the higher flexibility denotes an increasing portion of the compound material composition towards the intersection position. It is also possible to arrange the two different materials in a double layer, wherein a first layer comprises a first material and a second layer comprises a second material. Preferably, the two material layers are molded on top of each other. Preferably, the layer comprising the less flexible material comprises a decreasing layer thickness towards the intersection position, whereas the layer comprising the more flexible material comprises an increasing layer thickness towards the intersection position. Preferably, the layer thicknesses of the two layer either add to a constant overall material thickness or a decreasing overall material thickness towards the intersection position.

The objective of the invention is also reached by a method for manufacturing a refillable cartridge for an electronic smoking device, preferably according to any proceeding embodiment.

The method is characterized by the steps of:
providing an energy application device,
providing a housing for cartridge,
arranging the energy application device inside the housing and in controllable fluid communication with a liquid storage reservoir,
providing a sealing layer comprising a valve and arranging the sealing layer in an opening of the liquid storage reservoir, thereby closing the opening for liquids, and bringing the valve in fluid communication with an inner volume of the liquid storage reservoir.

Preferably the refillable cartridge is a cartridge according to any of the precedingly described embodiments. With the valve in the sealing layer it is very easy to refill the liquid storage reservoir through the valve without the need to completely remove the entire seal. In this way, any spilling of the liquid during refilling the refillable cartridge with new liquid can be prohibited.

The objective of the invention is also reached by a method for refilling a refillable cartridge for an electronic smoking device, preferably according to any of the preceding embodiments. The method is characterized by the steps of:
providing a refillable cartridge for an electronic smoking device, wherein the refillable cartridge comprises a first liquid storage reservoir having an opening, which is temporary closed by a sealing layer comprising a valve, wherein the valve comprises a valve member which comprises a hydrophobic material which is bendable in an opening direction,
providing a second liquid storage reservoir having elongated member having an outlet opening which is in fluid communication with the internal volume of the second liquid storage reservoir,
shifting the elongated member including its outlet opening through the valve, thereby bending at least a part of the valve member into the inner volume of the first liquid storage reservoir,
allowing a fluid to flow from the second liquid storage reservoir into the first liquid storage reservoir.

With this method a clean and easy refill of the refillable cartridge is possible. In particular, it is not necessary to remove the entire seal. In this way the probability of spilling any liquid during the refilling process is reduced. Also, the risk of losing the seal is reduced. Preferably the refillable cartridge is a refillable cartridge according to any of the previously discussed embodiments.

According to another embodiment the method is characterized by the step of allowing an outer surface of the valve member to contact an outer surface of the elongated member in a liquid-tight manner. This is preferably the case during the fluid flow from the second liquid storage reservoir into the first liquid storage reservoir. In this way, the liquid flowing from the second liquid storage reservoir into the first liquid storage reservoir cannot penetrate to an outside of the cartridge through the valve member. This makes the sealing even more spill-proof also during the refilling process.

According to another embodiment, an opening for gas transfer between the first liquid storage reservoir and a surrounding of the refillable cartridge is formed, wherein the opening is a further valve member preferably arranged between the hydrophobic material of the valve member and the elongated member. Preferably, this step takes place at the same time as when the elongated member is inserted into the valve. With the further valve member, a gas exchange during the refilling procedure from the first refillable cartridge to a surrounding of the refillable cartridge is possible. Preferably, the further valve member is a second part of at least one recess arranged remote from the intersection position. Preferably this embodiment is combined with at least two recesses comprising different length, in this embodiment the further valve member is positioned at the end of the longer of the two recesses.

### BRIEF DESCRIPTION OF THE DRAWINGS

Further advantages objectives and features of the present invention will be described, by way of example only, in the following description with reference to the appended figures. In the figures, like components in different embodiments can exhibit the same reference symbols. The figures show:

FIG. 1 a general view of the refillable cartridge 1 of the electronic smoking device 2,

FIG. 2 a detailed view of the valve 9 in the sealing layer 8,

FIG. 3a a sectional view of one embodiment of the sealing layer 8,

FIG. 3b a sectional view of another embodiment of the sealing layer 8,

FIG. 4 a sectional view of the sealing layer 8 during the refilling process,

FIG. 5 a schematic top view of the valve 9.

### DETAILED DESCRIPTION

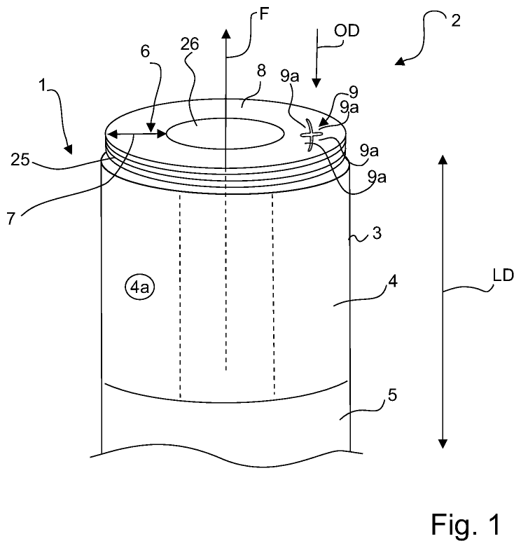

FIG. 1 shows a general view of the refillable cartridge 1 of the electronic smoking device 2. The refillable cartridge 1 comprises a liquid storage reservoir 4 in which liquid is storable. The stored liquid can be aerosolized with the energy application device 5. For clarity, the energy application device 5 is not shown completely. The aerosolized liquid is delivered along a flow-path F towards a mouth piece which is not shown in FIG. 1. The mouth piece may for example be affixed to the refillable cartridge at a thread 25. The refillable cartridge 2 comprises an opening 6 which is preferably a top opening. Preferably, the liquid storage reservoir 4 comprises the shape of a hollow cylinder with the flow path F arranged in a center hole 26. The opening 6 comprises an opening width 7. With the preferred shape of the hollow cylinder of the liquid storage reservoir 4, the liquid storage reservoir 4 comprises a longitudinal direction LD being perpendicular to base areas of the hollow cylinders shape. Preferably, the opening 6 is arranged on one of the base areas of the hollow cylinders shape of the liquid storage reservoir 4. In this case, the opening width 7 denotes a ring width, as the base area of a hollow cylinder comprises the shape of a ring. The opening 6 is closable with the sealing layer 8. The sealing layer 8 comprises a valve 9. The valve 9 comprises at least one valve member 9a, which overlaps with at least a part of the opening 6. The valve 9 may be opened in an opening direction OD pointing towards the inner volume 4a of the liquid storage reservoir 4. The at least 1 valve member 9a is bendable into the inner volume 4a of the liquid storage reservoir 4. With the sealing layer 8 arranged in the opening 6, the inner volume 4a of the liquid storage reservoir 4 is in enclosed by the cartridge housing 3 and the sealing layer 8.

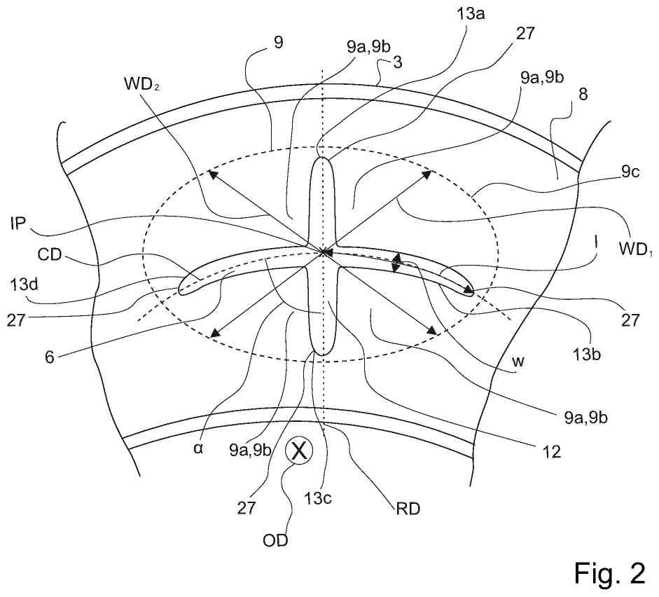

FIG. 2 shows a detailed top view of the sealing layer 8 with the valve 9. The valve 9 is marked in FIG. 2 with a dashed line. The valve 9 comprises at least one valve member 9a and an opening 12. The opening 12 preferably comprises elongated recesses 13a-b. In the shown embodiment, the opening 12 comprises four recesses 13a-d. The recesses 13a-d denote though-holes through the complete thickness of the sealing layer 8. The four recesses 13a-d are arranged in a cross shape. All four recesses 13a-d meet in the intersection position IP. In the shown embodiment the angle α between neighboring recesses is 90°. Other angles α are of course also conceivable. Between the recesses 13a-d the valve members 9a are arranged. A respective valve member 9a is arranged between two neighboring recesses 13a-b.

The recesses 13a-d each comprise a respective width and lengths. The respective length l of the respective recess 13a-d is measured from the intersection position IP towards a respective end 27 of the recess 13a-d. A respective width w of the respective recess 13a-d is measured perpendicular to its respective length l and in the plane of the lateral extent of the sealing layer 8. Preferably, the width w is 1 mm, more preferred 0.005-0.8 mm, even more preferred 0.01-0.6 mm, most preferred 0.02-0.5 mm. Preferably, the length is 0.5-10 mm, more preferred 0.75-7.5 mm, even more preferred 0.9-5 mm, most preferred 1-3 mm. The width w and the length l of the respective recesses 13a-d define the size of the opening 12. The recesses 13a-d do not all comprise the same length l. In the shown embodiment, each recess 13a-d comprises the same length l and width w as its opposing recess 13a-d. In the shown embodiment, the recesses 13a and 13c which are opposing, comprise the same length l and the same width w. Also, the opposing recesses 13b and 13d comprise the same length l and the same width w. Preferably, the width w of all recesses 13a-d is the same. Preferably, the length l of opposing recesses 13a and 13c, 13b and 13d is equal and the length l of non-opposing recesses, in other words neighboring recesses, is different. Preferably, two of the four recesses 13a, 13c are arranged parallel to a radial direction RD of the ring shape of the sealing layer 8. Preferably two other recesses 13b, 13d are arranged parallel to a circumferential direction CD of the ring shape of the sealing layer 8. Preferably, the recesses 13b, 13d arranged parallel to the circumferential direction CD follow the curvature of the circumference of the sealing layer 8. In a preferred embodiment the width w of all four recesses 13a-d is 0.5 mm and the opposing recesses 13a and 13c arranged in the radial direction RD comprise a respective length l₁ of 1.25 mm and the opposing recesses 13b and 13d arranged in the circumferential direction CD comprise a respective length l₂ of 2.5 mm.

Between two neighboring recesses 13a-d a respective valve member 9a is arranged. Each valve member 9a comprises bendable portions 9b. The bendable portion 9b is arranged towards the intersection position IP. The valve members 9a extends from an outer edge 9c of the valve 9 towards the intersection position IP along a respective width direction WD₁, WD₂. In the shown embodiment, which comprises four valve members 9a, two valve members 9a are opposing each other respectively. Each pair of opposing valve members 9a expands along a joint width direction WD₁ and WD₂. Preferably, the angle between the first width direction WD₁ and the second width direction WD₂ is 90°. Preferably, the angle between the first and second width direction WD₁, WD₂ to the radial direction RD and the circumferential direction CD is 45°.

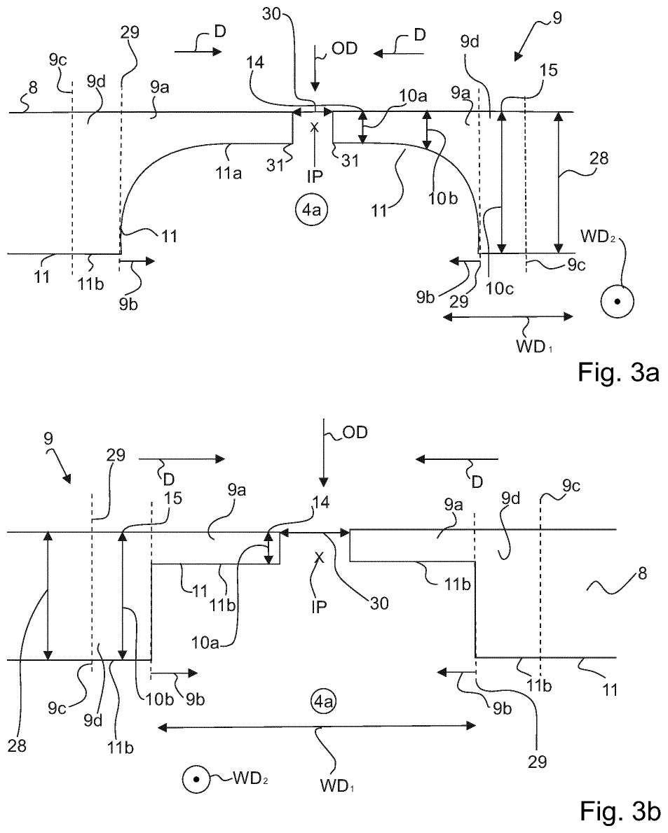

FIG. 3a shows a sectional view of the valve 9 sectioned along a width direction WD₁. In this sectional view, the thickness 10 of the valve member 9a together with the thickness 28 of the sealing layer 8 is visible. The layer thickness 10a of the valve member 9a at a position 14 close to the intersection position IP is smaller than a layer thickness 10c of the valve member 9a at a position 15 remote from the intersection position IP. In other words, the thickness 10 of the valve member 9a decreases from an outer edge 9c of the valve 9 along a direction D towards the intersection position IP. This decrease of the thickness 10 may either be a continuous decrease or may also be a stepwise decrease. Preferably, the thickness 10c of the valve member 9a at a position 15 remote from the intersection position IP equals a layer thickness 28 of the sealing layer 8. In this way, the valve members 9a merges seamlessly into the sealing layer 8 at the outer edge 9c of the valve 9.

From a position 29 located between the remote position 15 and the position 14 close to the intersection position IP, the layer thickness 10 of the valve member starts to decrease towards the intersection position IP. This means that the thickness 10b of the valve member 9a measured at the position between the position 29 and the position 14 close to the intersection position IP is smaller than the thickness 10c measured at the position 15 remote from the intersection position IP and larger than the thickness 10a measured at the position 14 close to the intersection position IP. With the decreasing thickness 10, the part of the valve member 9a comprising the decreasing layer thickness is bendable. This portion is therefore referred to as the bendable portion 9b of the valve member 9a. In contrast to that, a portion of the valve member 9a in which the layer thickness 10 is not decreased in comparison to a layer thickness 28 of the sealing layer 8 is non-bendable. Therefore, this portion is referred to as the non-bendable portion 9d of the valve member 9a. The non-bendable portion 9d merges into the bendable portion 9b at the position 29, at which the decrease of the thickness 10 towards the intersection position IP starts.

The sealing layer 8 comprises a surface 11, which is arranged towards the inner volume 4a of the liquid storage reservoir 4. In the shown embodiment, the surface 11 comprises a curved portion 11a and a straight portion 11b. The curved portion 11a is arranged at the bendable portion 9b of the valve member 9a. In contrast to that, the straight portion of 11b is arranged at the non-bendable portion 9d of the valve member 9a. The straight portion 11b is preferably parallel to the width direction WD₁. With the curvature of the curved portion 11a, the thickness 10 of the valve member 9a is reduced towards the intersection position IP. The curved portion 11a of the surface 11 extends from the position 29 separating the curved portion 11a from the straight portion 11b towards a tip 31 of the valve member 9a. The tip 31 is the point of the valve member 9a arranged closest to the intersection position IP. However, the tip 31 of the valve member 9a does not completely reach the intersection position IP. Between two opposing valve members 9a, the intersection position IP is arranged in a gap 30 between the opposing tips 31 of the two opposing valve members 9a.

FIG. 3b shows a sectional view of the sealing layer 8 in another embodiment. In contrast to the embodiment shown in FIG. 3a, the embodiment shown in FIG. 3b does not comprise a curved portion 11a of the surface 11 of the sealing layer 8 but only straight portions 11b of the surface 11 of the sealing layer 8. This means, that the decrease of the thickness 10 of the valve member 9a is not a continuous decrease but a stepwise or cascading decrease. The shown embodiment is the simplest version of a stepwise decrease of the thickness 10. The shown embodiment comprises only two different thicknesses 10a and 10b. The smaller thickness 10a is the thickness of the bendable portion 9b of the valve member 9a. The thicker thickness 10b is the thickness of the non-bendable portion 9d of the valve member 9a. The thickness 10 exhibits a step decrease at the position 29 at which the bendable portion 9b of the valve member 9a merges into the non-bendable portion 9d. This implies, that the thickness 10a of the bendable portion 9b is constant and equal to the smaller thickness 10a. The larger thickness 10b of the non-bendable portion 9d preferably equals the layer thickness 28 of the sealing layer 8. It is of course conceivable that more than two different thicknesses 10 are realized. This would result in more than one stepwise decrease of the thickness 10. In particular, this would result in a step-like decrease of the thickness 10 comprising multiple distinctive steps.

The bendable portions 9b of the valve 9 shown in FIGS. 3a and 3b are all bendable towards an inner volume 4a of the liquid storage reservoir 4. This bending corresponds to a movement of the tip 31 of the valve member 9a in the opening direction OD. In addition to this movement, the tips 31 of the valve members 9a are also moved slightly towards the outer edge 9c of the valve 9. This equals a movement of the tips 31 of the valve members 9a in a direction opposite to the direction D pointing towards the intersection position IP. In other words, the tips 31 of the valve members 9a are moved outwards and away from the intersection position IP together with the movement of the tips 31 in the opening direction OD. The tips 31 move inwards into the inner volume 4a of the liquid storage reservoir 4 in a rotatory movement. This rotatory movement comprises a rotational axis parallel to the width direction WD₂ which is arranged perpendicular to the paper plane of FIGS. 3a and 3b.

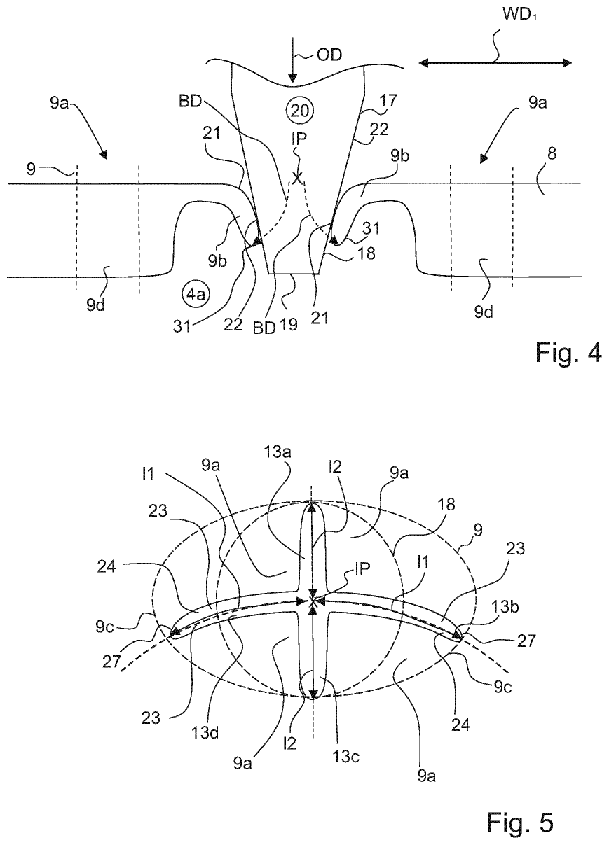

FIG. 4 shows a sectional view of the valve 9 during the refilling process. For refilling the liquid storage reservoir 4, hereinafter referred to as the first liquid storage reservoir 4, an elongated member 18 of a second liquid storage reservoir 17 is inserted into the valve 9 of the sealing layer 8 of the refillable cartridge 1. The elongated member 18 is preferably shaped like a nozzle. The elongated member 18 comprises an outlet opening 19 at its tip. Through the outlet opening 19 of the second liquid storage reservoir 17, liquid from an internal volume 20 of the second liquid storage reservoir 17 can be transferred into the inner volume 4a of the first liquid storage reservoir 4. Upon insertion of the elongated member 18 into the valve 9, the bendable portions 9b of the valve member 9a are bent towards the inner volume 4a of the first liquid storage reservoir 4. The rotatory movement of the tips 31 of the valve members 9a mentioned before is illustrated in FIG. 4 with the bending direction BD shown in dashed arrows. The outer surface 21 of the valve member 9a is in contact with the outer surface 22 of the elongated member 18. Preferably, the outer surface 21 of the valve member 9a is in sealing contact with the outer surface 22 of the elongated member 18. This means, that there is no fluid flow between the outer surface 21 of the valve member 9a and the outer surface 22 of the elongated member 18 when these two surfaces 21, 22 are in contact.

FIG. 5 shows a schematic top view of the valve 9 with a circular dashed line representing the cross-section of the elongated member 18. FIG. 5 shows the valve members 9a in the unbent position for clarity. The dashed circle representing the elongated member 18 is only shown schematically to elucidate where the elongated member 18 would be positioned when inserted into the valve 9. In the shown embodiment, the diameter of the elongated member 18 corresponds to approximately twice the length l₂ of the shorter recesses 13a and 13c. The two longer recesses 13b and 13d comprise a length l₁ which is larger than the length l₂. In this way, the longer recesses 13b and 13d exceed the diameter of the elongated member 18. This results in a respective portion of the recesses 13b and 13d being unoccupied by the elongated member 18 when it is inserted into the valve 9. These portions denote an opening 23 as they are not blocked by the elongated member 18. These openings 23 are arranged in the recesses 13b and 13d towards their ends 27 which are distanced from the intersection position IP and close to the outer edge 9c of the valve 9. These openings 23 are not blocked by the elongated member 18 during the refill process. This means that fluidic exchange, in particular gas exchange, through the openings 23 from an inner volume 4a of the first liquid storage reservoir 4 to a surrounding of the refillable cartridge 1 is possible. Therefore, the openings 23 act as a valve to let air escape from the inner volume 4a of the first liquid storage reservoir 4 to make room for the refilled liquid. Therefore, the openings 23 are referred to as further valve members 24.

In the shown embodiment, the longer recesses 13b and 13d exceed the radius of the circular cross-section of the elongated member 18 and the shorter recesses 13a and 13c comprise approximately the same length l₂ as the radius of the circular cross section of the elongated member 18. However, it is also conceivable that only one of the recesses 13a-d exceeds the radius of the circular cross-section of the elongated member 18 with its length l. It is also conceivable, that more than two or even all recesses 13a-d exceed the radius of the circular cross-section of the elongated member 18 with their length l. The number of recesses 13a-d exceeding the radius of the circular cross-section of the elongated member 18 with their lengths l defines the number of openings 23 and therefore the number of further valve members 24. It is preferred that the valve 9 comprises at least one further valve member 24. This implies that at least one length of at least one recess 13a-d should exceed the radius of the circular cross-section of the elongated member 18.

The applicant reserves his right to claim all features disclosed in the application document as being an essential feature of the invention, as long as they are new, individually or in combination, in view of the prior art. Furthermore, it is noted that in the figures features are described, which can be advantageous individually. Someone skilled in the art will directly recognize that a specific feature being disclosed in a figure can be advantageous also without the adoption of further features from this figures. Furthermore, someone skilled in the art will recognized that advantages can evolve from a combination of diverse features being disclosed in one or various figures.

### LIST OF REFERENCE SYMBOLS

1 refillable cartridge
2 electronic smoking device
3 cartridge housing
4 (first) liquid storage reservoir
4a inner volume
5 energy application device
6 opening
7 opening width
8 sealing layer
9 valve
9a valve member
9b bendable portions
9c outer edge of valve
9d non-bendable portion
10 thickness of valve member
11 surface of sealing layer
11a curved portion
11 b straight portion
12 openings of the valve
13a-d recesses
14 position close to intersection position
15 position remote to intersection position
16 curvature of opening
17 second reservoir
18 elongated member
19 outlet opening
20 internal volume of second reservoir
21 surface of valve member
22 outer surface of elongated member
23 opening
24 further valve member
25 thread
26 center hole
27 end
28 thickness of sealing layer
29 position
30 gap
31 tip of valve member
α angle
w width of recess
l length of recess
F flow path
WD width direction
OD opening direction
IP intersection position
D direction towards intersection position
LD longitudinal direction
BD bending direction

1. A refillable cartridge for an electronic smoking device comprising a cartridge housing, a liquid storage reservoir, and an energy application device for generating an aerosol from liquid received from the reservoir, wherein the reservoir comprises an opening having an opening width, configured to be temporarily closed by a sealing layer comprising a valve, wherein the valve comprises a valve member which is overlapping at least parts with the opening along its a width direction,
wherein the valve member is bendable in an opening direction, which is orthogonal to the width direction, and a thickness of the valve member in the opening direction differs along the width direction.

2. The refillable cartridge according to claim 1, wherein:
the sealing layer and the valve member comprise the same material.

3. The refillable cartridge according to claim 1, wherein:
a surface of the sealing layer and/or the valve member which is arranged towards the storage reservoir comprises a hydrophobic material.

4. The refillable cartridge according to claim 1, wherein:
the valve provides openings which allow passing of gases through the valve in a state in which transfer of liquids is inhibited.

5. The refillable cartridge according to claim 1, wherein:
the valve member is defined by two or more elongated recesses which intersect each other in an intersection position, wherein the two or more elongated recesses extend from the intersection position in an angle of ≥45° with respect to each other.

6. The refillable cartridge according to claim 5, wherein:
the thickness of the valve member follows a thickness profile having a reduced thickness in a position closer to the intersection position than remote to the intersection position.

7. The refillable cartridge according to claim 6, wherein:
the thickness profile of the thickness of the valve member has a continuous or stepwise decreasing thickness in a direction towards the intersection position.

8. The refillable cartridge according to claim 5, wherein:
at least one of the two or more elongated recesses follows a curvature of the opening.

9. The refillable cartridge according to claim 5, wherein:
at least one of the two or more elongated recesses has a width of ≤1 mm.

10. The refillable cartridge according to claim 5, wherein:
at least one of the two or more elongated recesses has a length of ≥0.5 and ≤10 mm.

11. The refillable cartridge according to claim 5, wherein:
flexibility of the valve member increases along the width direction towards the intersection position.

12. A method for manufacturing a refillable cartridge for an electronic smoking device, comprising:
providing an energy application device,
providing a housing for a cartridge,
arranging the energy application device inside the housing and in controllable fluid communication with a liquid storage reservoir,
providing a sealing layer comprising a valve, and arranging the sealing layer in an opening of the liquid storage reservoir, thereby closing the opening for liquids and bringing the valve in fluid communication with an inner volume of the liquid storage reservoir.

13. A method for refilling a refillable cartridge for an electronic smoking device, comprising:
providing a refillable cartridge for an electronic smoking device, wherein the refillable cartridge comprises a first liquid storage reservoir having an opening, which is temporarily closed by a sealing layer comprising a valve, wherein the valve comprises a valve member which comprises a hydrophobic material and which is bendable in an opening direction,
providing a second liquid storage reservoir having an elongated member having an outlet opening which is in fluid communication the an internal volume of the second liquid storage reservoir,
shifting the elongated member including the outlet opening through the valve, thereby bending at least a part of the valve member into an inner volume of the first liquid storage reservoir,
allowing a fluid to flow from the second liquid storage reservoir into the first liquid storage reservoir

14. The method for refilling a refillable cartridge according to claim 13, further comprising:
allowing an outer surface of the valve member to contact an outer surface of the elongated member in a liquid-tight manner.

15. The method for refilling a refillable cartridge according to claim 13,
forming an opening for gas transfer between the first liquid storage reservoir and a surrounding of the refillable cartridge, wherein the opening for gas transfer is a further valve member arranged between the hydrophobic material of the valve member and the elongated member.

16. The refillable cartridge according to claim 1, wherein:
the sealing layer and the valve member comprise a hydrophobic material.

17. The refillable cartridge according to claim 1, wherein:
the valve member is defined by four or more elongated recesses which intersect each other in a single intersection position, wherein the four or more elongated recesses extend from the intersection position in an angle of ≥45° with respect to each other.

18. The refillable cartridge according to claim 1, wherein:
the valve member is defined by two or more elongated recesses which intersect each other in an intersection position, wherein the two or more elongated recesses extend from the intersection position in an angle of ≥90° with respect to each other.

19. The refillable cartridge according to claim 5, wherein:
at least one of the two or more elongated recesses has a width of ≥0.02 and ≤0.5 mm.

20. The refillable cartridge according to claim 5, wherein:
at least one of the two or more elongated recesses has a length of ≥1 and ≤3 mm.
